(19) United States
(12) Patent Application Publication
(10) Pub. No.: US 2016/0114225 A1
(43) Pub. Date: Apr. 28, 2016

(54) Golfing Accessory

(71) Applicants: David-Douglas Brown, North Brunswick, NJ (US); Virginia Brown, North Brunswick, NJ (US); Douglas T. Brown, North Brunswick, NJ (US)

(72) Inventors: David-Douglas Brown, North Brunswick, NJ (US); Virginia Brown, North Brunswick, NJ (US); Douglas T. Brown, North Brunswick, NJ (US)

(21) Appl. No.: 14/924,504

(22) Filed: Oct. 27, 2015

Related U.S. Application Data
(60) Provisional application No. 62/068,850, filed on Oct. 27, 2014.

(51) Int. Cl. A63B 47/04; B08B 1/00; A63B 57/50

(52) U.S. Cl. CPC A63B 47/04; A63B 57/50; B08B 1/006; A63B 2047/043

(57) ABSTRACT

The present invention pertains generally to golf accessories for use by a golfer. More particularly, the present invention pertains to a golfing accessory consisting of a magnetic element attached or embedded in a microfiber cleaning cloth, where the magnet is capable of being used to hold various additional components of the tool while allowing a desired component to be quickly detached from the tool. The present invention is particularly, but not exclusively, useful as a tool to allow golfers quicker and easier access to the necessary components of the tool while the golfer is engaged in a round of golf.

### FIELD OF THE INVENTION

The present invention pertains generally to golf accessories for use by a golfer. More particularly, the present invention pertains to a tool consisting of a magnetic element attached or embedded in a microfiber cleaning cloth, where the magnet is capable of being used to hold various additional components of the tool while allowing a desired component to be quickly detached from the tool. The present invention is particularly, but not exclusively, useful as a tool to allow golfers quicker and easier access to the necessary components of the tool while the golfer is engaged in a round of golf.

### BACKGROUND OF THE INVENTION

Golf is a favorite pastime, and over the years a large variety of golf-related products have been developed. These products include, among others, various ball-cleaning devices, divot repair tools, ball markers, and a virtually unlimited variety of golf clubs and bags.

To improve their game, many golfers carry a towel to wipe or clean their golf clubs. In addition, having a clean golf ball is also important because sand, dirt, grass, or mud that accumulates on the surface of the ball may cause the golf ball to veer off course from the golfer's intended shot. However, using a towel to clean a golf ball can be inconvenient when a golfer is currently engaged in a round due to the towel's size and golfers' unwillingness to carry a large towel. Some courses provide a ball washing unit that a golfer uses before teeing off. Unfortunately, these ball washing units are typically offered only at the beginning of a course, leaving a golfer to resort to his or her clothes as a means of cleaning their golf ball.

In addition, many golfers use a ball marker to mark the location of a golf ball is an important element of golf etiquette. If a golf ball sits between another players ball and the hole, it should be marked with a marker or other small item, such as a coin. Once the other player has taken their turn, the golf ball is returned to the spot held by the marker.

A divot tool is a fork-like implement that “fixes” divots caused by the impact of a golf ball on the green. When the green is soft and the bail lands on it at a steep angle, it creates a dent in the ground called a “divot.” A divot tool works by sticking the forks of the divot tool into the green around the indentation and lifting slightly. Once the divot has been raised to level with the rest of the green, the divot is patted down with the sole of a putter, another golf club, or even a golfer's foot, to level the top of the now repaired divot with the green or fairway.

Divot tools that hold a ball marker are a common golf accessory. By combining these two items, manufacturers have provided golfers with only one item to carry that contains these two accessories. These combination tools are often made of metal. The divot tool usually has a circular indentation containing a magnet that allows the marker to stick to it. Other tools have a clip to hold the marker.

In light of the need for the above described products, it would advantageous to provide an economic and efficient manner for a golfer to have ready access to all tools needed during a round of golf and still legal to use in Tournament or competitive golf. It would be further advantageous to provide a combination accessory which would include all golf-related needs in a single device so that the golfer can readily access the tools as needed without having to root around in as golf bag in search of the needed golf accessory and delaying play.

### SUMMARY OF THE INVENTION

In a preferred embodiment, the present invention consists of magnet embedded or attached to a microfiber cloth. Microfiber cloths typically consist of a mixture of polyester and polyamide microfibers. In caparison to normal cotton cloths, the fibers of a microfiber cloth are thinner and longer, therefore creating a larger surface area. Both the arrangement and properties of the polyester and polyamide microfibers allow the microfiber cloth to absorb water, oils, and dirt more efficiently with a smaller volume.

The magnet embedded or attached to a microfiber cloth can be used in conjunction with multiple accessories. In one alternative embodiment, the Golfing Accessory of the present invention consists of a divot tool portion and a cloth portion; the cloth portion consisting of the magnet embedded or attached to a microfiber cloth.

The divot tool portion may have recessed edges thereby creating an indented space for the marker. Having an indented space protects the edges of the marker from catching on another edge or piece of clothing possibly leading to the marker detaching from the divot tool portion and becoming lost. The divot tool portion may also contain a lever partially disposed under the marker portion to allow a user to press on the lever to free the marker portion from the divot tool portion. Alternatively, the divot tool portion may have a finger slot located along the edge of the recessed area of the divot tool portion to allow a golfer to use his or her finger to pull the marker portion away from the divot tool portion.

The cloth portion may be constructed from a microfiber material, as discussed above, or may be constructed from cotton, or any other cloth like material known in the industry that can be used to clean a golf ball. The cloth portion may also be used to clean a golfer's glasses. In addition, the cloth portion may be permanently attached to the divot tool portion of the combination tool or it may be detachable using the magnetic field produced by the magnet attached or embedded within the microfiber cloth.

In addition, the Golfing Accessory of the present invention can be attached to a user's body or golf bag through the use of a clip.

The Golfing Accessory may also be magnetically attached to, for example, a golf bag. In use, the cloth portion of the Golfing Accessory is removed from its mounting location and used to clean the gold ball.

A marker could be coupled with the magnet embedded or attached to the microfiber cloth. If a marker is needed, a user can quickly and easily remove the marker from the Golfing Accessory and place the marker on the ground. Further, if a user's golf ball has accumulated mud or dirt on its surface, the user can quickly and easily reach the Golfing Accessory of the present invention and use the cloth portion to clean the golf ball. The marker portion may be attached to any previously mentioned embodiment, including the cloth portion, the cloth portion used in conjunction with the divot repair tool, the cloth portion used in conjunction with a clip, and an embodiment in which all the aforementioned components are used.

In addition, while many rules and regulations govern golf tournaments and competitive play, all of the various embodiments and combinations of embodiments subsequently described in greater detail, do not violate any rules or regulations and are legal to use in golf tournaments and competitive play.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the cloth portion of the Golfing Accessory of the present invention, showing a magnet attached to a microfiber cloth;

FIG. 2 is a front view of the cloth portion of the Golfing Accessory of the present invention, showing the magnet attached to a rectangular microfiber cloth fully extended with a logo on the microfiber cloth;

FIG. 3A is the front view of a clip used in conjunction with the cloth portion of the Golfing Accessory of the present invention, showing a flat circular face and the top portion a hook;

FIG. 3B is a side view of the clip used in conjunction with the cloth portion of the Golfing Accessory of the present invention taken along lines 3B-3B of FIG. 3A, showing the flat circular face and hook of the clip;

FIG. 4 is a front view of an alternative embodiment of the Golfing Accessory of the present invention, showing the cloth portion magnetically attached to the flat circular face of the clip;

FIG. 5 is a front view of a divot tool, showing two forks and the divot tool head;

FIG. 6 is a front view of an alternative embodiment of the Golfing Accessory of the present invention, showing the cloth portion magnetically attached to the divot tool of FIG. 5;

FIG. 7 is a front view of an alternative embodiment of the Golfing Accessory of the present invention, showing a marker magnetically attached to the magnet of the cloth portion;

FIG. 8 is an exploded view of the alternative embodiment of the Golfing Accessory of the present invention, showing the marker, magnet, and microfiber cloth;

FIG. 9 is the front view of an alternative embodiment of the Golfing Accessory of the present invention, showing a magnet in dashed lines enclosed between a separate piece of microfiber cloth, also in dashed lines, and the microfiber cloth;

FIG. 10 is the front view of an alternative configuration of the Golfing Accessory of the present invention, showing a microfiber cloth, magnet, and marker, attached magnetically to a clip hanging on the belt of the user; and

FIG. 11 is the front view of the alternative embodiment of the Golfing Accessory of the present invention as shown in FIG. 7, showing the Golfing Accessory located within the pocket of the user's clothing.

### DETAILED DESCRIPTION

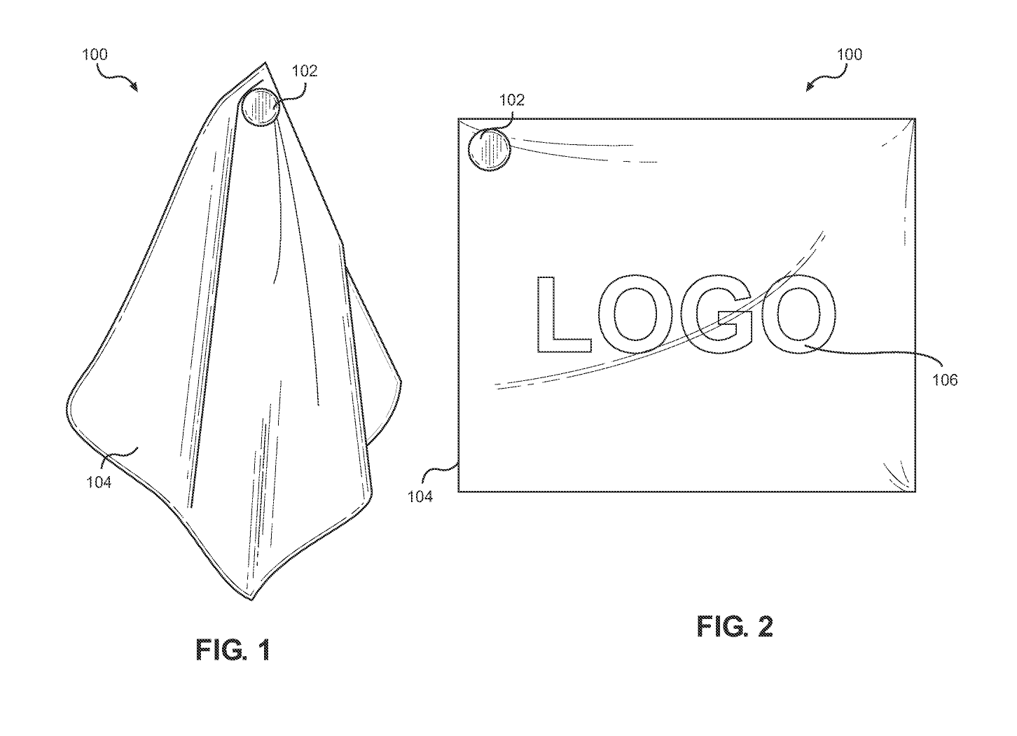

Referring initially to FIG. 1, the cloth portion of the Golfing Accessory of the present invention is shown and generally designated 100. The cloth portion 100 consists of a magnet 102 attached to or embedded in a microfiber cloth 104. Microfiber cloths typically consist of a mixture of polyester and polyamide microfibers. In comparison to normal cotton cloth, the fibers of a microfiber cloth 104 are thinner and longer, therefore creating a larger surface area having a higher degree of abrasiveness with which to clean. Both the arrangement and properties of the polyester and polyamide microfibers allow the microfiber cloth 104 to absorb water and oils with a smaller volume, yet shed dirt more efficiently. In addition, microfiber cloths 104 dry at a faster rate and the dirt accumulated by the microfibers can be easy brushed off the microfiber cloth 104.

In FIG. 2, the cloth portion 100 of the Golfing Accessory is shown. Here, the microfiber cloth 104 is extended to show its full area. Although shown in FIG. 2 as rectangular in shape, the microfiber cloth 104 can vary in size, shape, color, and can also have various designs and patterns and may be woven or pre-printed with a logo 106 to represent an advertiser, promoter, or special event.

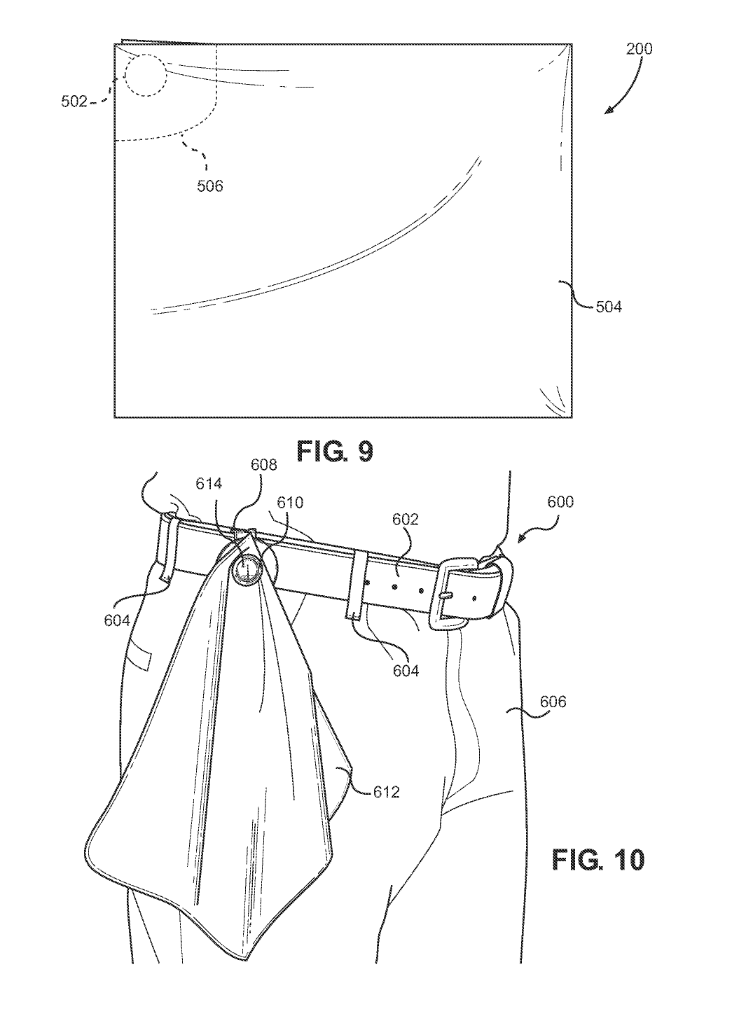

As shown, the magnet 102 is located in the corner of the microfiber cloth 104 in order to provide enough surface area to fully clean the golf ball. The magnet 102 may be attached to the exterior surface of the cloth 104, embedded in the microfiber cloth 104 by any means known in the art including, but not limited to, various types of adhesives, rivets, snaps, mechanical fasteners, and the like, Although one (1) magnet 102 is shown in FIGS. 1-11, multiple magnets 104 may be used and located at various positions on the cloth 104. Also, the magnet 102 may be sewn within the microfiber cloth 104 as will be described below in conjunction with FIG. 9. In addition, the magnet 102 may be located in various locations on the microfiber cloth 104 without deviating from the spirt and scope of the present invention.

The cloth portion 100 of the Golfing Accessory of the present invention may be attached to any surface attracted to the magnet. Some examples include the metal portion of a belt or golf bag. To use the present invention, the user removes the cloth portion 100 from the surface attracted to the magnet 102. The user then cleans the ball (not shown) using the microfiber cloth 104. If the user has attached the cloth portion 100 to, for example, the buckle of his or her belt, removal of the cloth portion 100 of the Golfing Accessory of the present invention is not necessary.

As stated above, the cloth portion 100 may be attached to various surfaces attracted to the magnetic field created by the magnet 102. In addition, the cloth portion 100 may also be used in conjunction with multiple accessories.

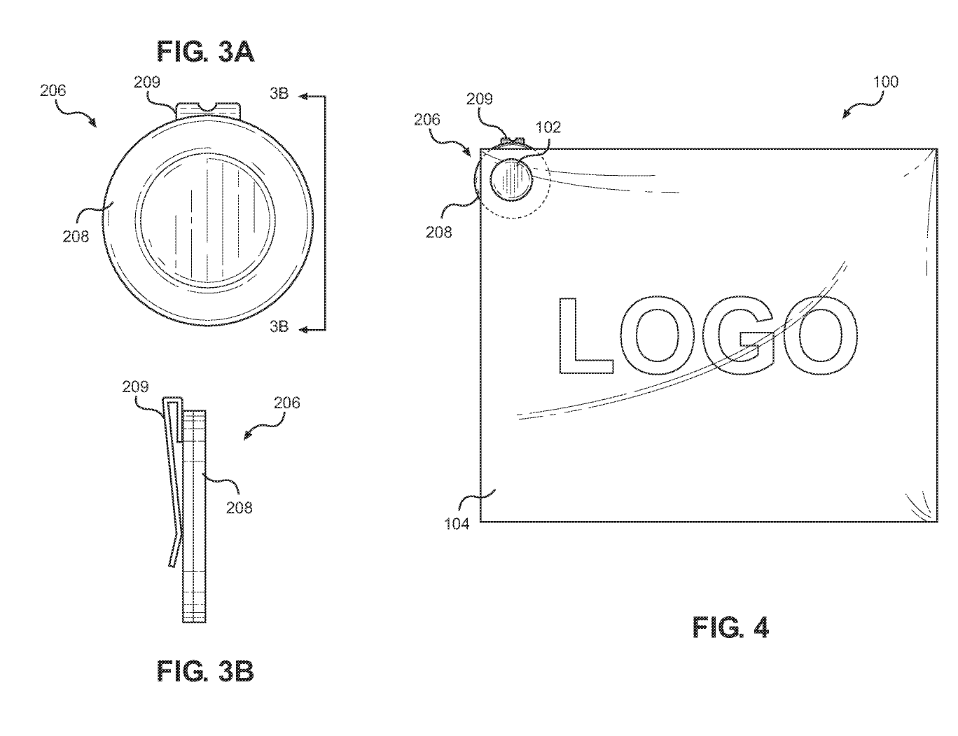

Referring to FIGS. 3A-B, alternative views of a belt clip 206 are shown. The clip consists of a flat face 208 formed with a hook 209 configured to hang the clip 206 on the user's pants, shirt, golf bag, etc. Although shown in FIG. 3A as circular, the flat face 208 of the clip 206 may be various shapes including, but not limited to, rectangular, diamond, oval, oblong, etc. The face 208 of the clip 206 may also have various volumes and three dimensional shapes that are not flat. The clip 206 may be made of various metals, alloys, or any other material capable of attracting the magnetic field of the magnet 102 of the cloth portion 100. In addition, although a hook 209 is used to attach the clip 206 to the user's pants, shirt, golf bag, etc, any attachment mechanism known in the art may be used.

In FIG. 4, the assembled alternative embodiment of the Golfing Accessory of the present invention is shown and generally designated 200. In this embodiment, the cloth portion 100 is magnetically attached to the flat face 208 of clip 206 via the magnetic field created by magnet 102. The user then cups the clip 206 on his or her pants, shirt, golf bag, etc. using the hook 209 of clip 206. When needed, the user simply removes the cloth portion 100 from the clip 206 and uses the microfiber cloth 104 to clean the user's golf ball, glasses, etc. After use, the user can reattach the cloth portion 100 of the Golfing Accessory 200 to the clip 206 simply by placing magnet 102 adjacent flat face 208 such that the magnetic field will engage the two, until it is needed again.

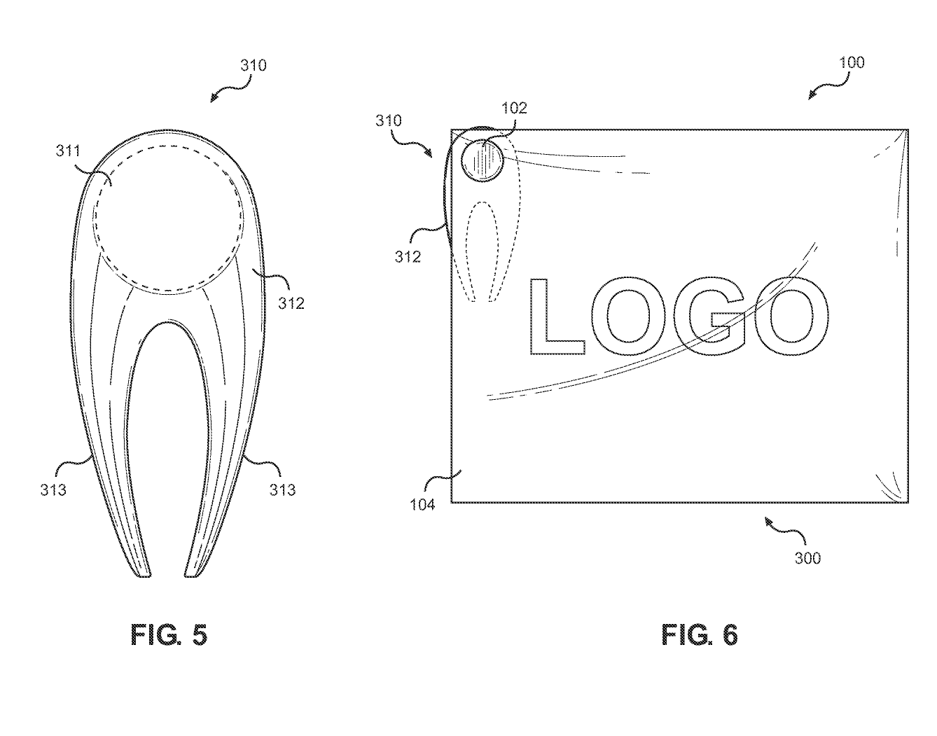

Now referring to FIG. 5, the front view of a divot tool 310 is shown. As stated above, a divot tool 310 is a fork-like implement that loosens the impacted dirt surrounding a divot caused by the impact of a golf ball on the green. A typical divot tool 310 is formed with two forks 313 and a head 312. The user holds the divot tool 310 by the head 312 and pushes the forks 313 into the soil surrounding the divot in order to loosen the soil. The divot tool 310 may be made of various materials so long as the entire divot tool 310 or portions of the divot tool 310 are made of a material capable of being attracted to a magnetic field. Alternatively, the divot tool 310 may be made from a non-ferrous material, such as plastic, and equipped with a ferrous element 311 (shown in phantom) that provides the magnetic attraction to magnet 102 of clot 100. Although shown in this configuration, the divot tool 310 may be configured in various ways known to those skilled in the art.

In FIG. 6, an alternative embodiment of the Golfing Accessory of the present invention is shown and generally designated 300. In this embodiment of the Golfing Accessory 300, the cloth portion 100 is magnetically attached to the head 312 of the divot tool 310. When needed, the user simply removes the cloth portion 100 from the divot tool 310 and uses the microfiber cloth 104 to clean the user's golf ball, glasses, etc. or uses the divot tool 310 to repair a divot. After use, the user can reattach the cloth portion 100 of the Golfing Accessory 300 to the divot tool 310 until it is needed again. The Golfing Accessory 300 may be attached to any magnetically attracted surfaces including, but not limited to, the belt buckle or golf bag of the user. In addition, Golfing Accessory 300 may also be attached to clip 206 (shown in FIGS. 3A-B and 4) to create a Golfing Accessory that includes a divot tool 310 and microfiber cloth 104 magnetically attached to the clip 206.

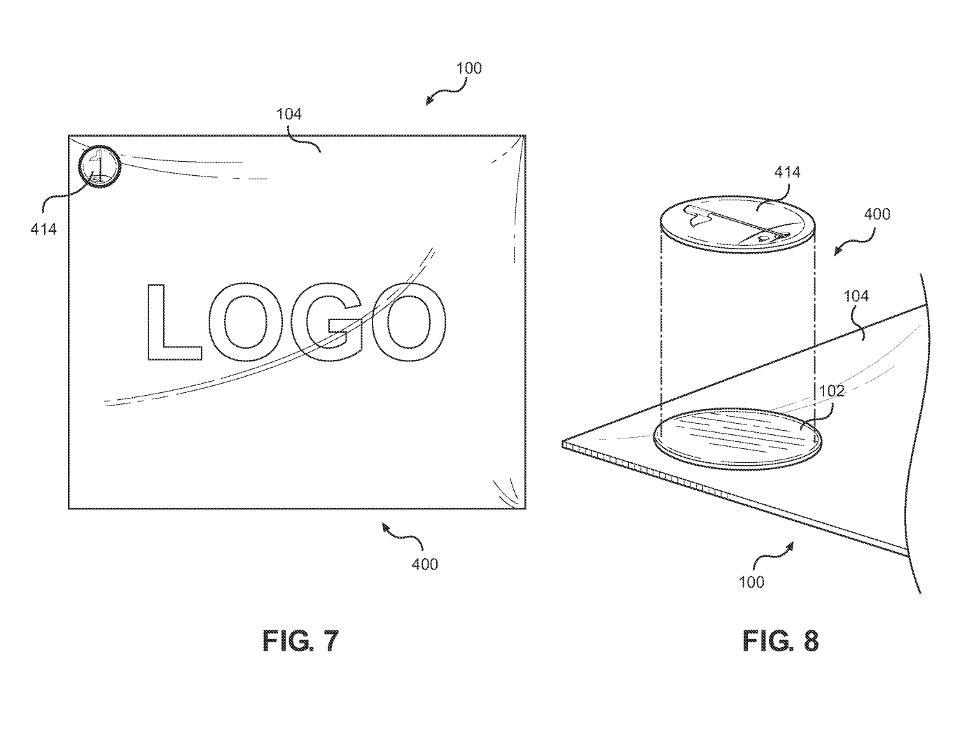

Now referring to FIG. 7, an alternative embodiment of the Golfing Accessory of the present invention is shown and generally designated 400. In this embodiment, a marker 414 is magnetically attached to the magnet 102 of cloth portion 100. FIG. 8 depicts an exploded view of the Golfing Accessory 400 showing the magnet 102 of the cloth portion 100 of the Golfing Accessory 400 located beneath the marker 414. The marker 414 may be made of various shapes, sizes, colors, and have various designs, logos, insignia, etc. located on the marker 414. The marker 414 can be formed using various materials so long as the entire marker 414 or portions of the marker 414 consist of a ferrous material capable of being attracted to a magnetic field. In a preferred embodiment shown in FIGS. 7 and 8, the marker 414 is disc-shaped. While FIGS. 7 and 8 shown one (1) marker 414 attached to the magnet, multiple markers 414 may be used and either stacked on one another, or located on various magnets 102, if multiple magnets 102 are used.

As stated above, using a marker 414 to mark the location of a golf ball is an important element of golf etiquette. If a golf ball sits between another player's ball and the hole, it should be marked with a marker 414. Once the other player has taken their turn, the golf ball is returned to the spot held by the marker 414. A marker 414 may also be used to mark the location of a ball if the golf ball needs to be cleaned. To use the Golfing Accessory 400 as shown in FIGS. 7-8, the user would detach the marker 414 from the cloth portion 100 and mark the location of his or her ball. The user would then use the microfiber cloth 104 from the cloth portion 100 to clean the ball. After use, the user would return the marker 414 to the magnet 102 of the cloth portion 100.

The Golfing Accessory 400 may be attached to magnetically attracted surfaces including, but not limited to, the belt buckle or golf bag of the user. In addition, Golfing Accessory 300 may also be attached to a divot tool 310 (as shown in FIG. 5). The alternative embodiment of Golfing Accessory 400 may also be attached to clip 206 (shown in FIGS. 3A-B and 4) to create a Golfing Accessory that includes a marker 414 and microfiber cloth 104 magnetically attached to the clip 206.

Referring now to FIG. 9, an alternative embodiment of the cloth portion of the Golfing Accessory is shown and generally designated 500. The enclosed magnet 502 is shown using dashed lines. In this embodiment, magnet 502 is enclosed within the microfiber cloth 504 by various means known in the art. For example, the magnet may be covered by a separate piece of microfiber cloth 506 (shown in dashed lines) and attached to the microfiber cloth 504 enclosing the magnet 502 into a pocket. Another example would be a pocket formed in the microfiber cloth 504. This would allow the user to remove the magnet 502 and wash the microfiber cloth 504. Alternatively, the microfiber cloth 504 may consist of two ply material, with the magnetic 502 being sandwiched between the layers of the two ply material.

The cloth portion 500 shown in FIG. 9 may be used in lieu of the cloth portion 100 described in FIG. 1-2 in any embodiment previously discussed.

Referring now to FIG. 10, an alternative configuration of the Golfing Accessory of the present invention is shown and generally designated 600. Golfing Accessory 600 is shown attached to a belt 602 passing through belt loops 604 on pants 606. Golfing Accessory 600 includes a belt clip having a magnetic element which allows the magnet 610 of cloth 612 to be easily attached and worn during golf. A marker 614 can also be attached to the magnet 610 opposite clip 608 and likewise easily removed for use during play, Cloth 612 may be used while connected to belt 602 through clip 608, or the combination of the cloth 612 with marker 614 may be removed for use.

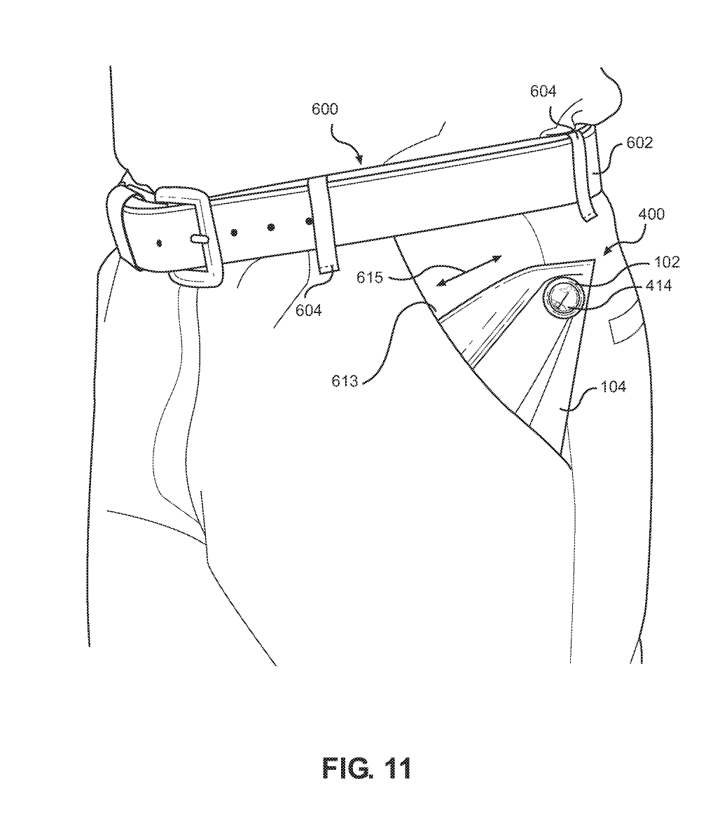

In FIG. 11 an alternative means of storing the alternative embodiment of the Golfing Accessory 400 (as shown in FIGS. 7-8) is shown. The user may carry the Golfing Accessory 400 of the present invention within the pocket 613 of the user's pants 606. The user may remove the Golfing Accessory 400 from the pocket 613 for use and return the Golfing Accessory 400 to the user's pocket as indicated by the accompanying directional arrows 615.

Although described above as the users pants 606, the Golfing Accessory 400 may be stored in the pocket 613 any article of clothing worn by the user. In addition, although depicted in FIG. 11 as the alternative embodiment of the Golfing Accessory 400 of the present invention, any previously discussed embodiments or any combination of the previously discussed components may be stored within the user's pocket 613.

It is to be appreciated that the various magnetic elements described herein include a variety of metals which have magnetic properties sufficient to retain the various tool components together. It is also to be appreciated that while the magnetic element described herein has been primarily the magnet 102 on cloth 104, it is also within the scope of this invention that the magnet is contained within the marker, the clip, the divot tool, or any other combination such that the components, when placed adjacent to each other, will be retained in place through the magnetic attraction of the magnet, and the other ferrous components.

In addition, as stated above, all of the embodiments and combinations of embodiments described above, do not violate any rules or regulations and are legal to use in golf tournaments and competitive play.

While there have been shown what are presently considered to be preferred embodiments of the present invention, it will be apparent to those skilled in the art that various changes and modifications can be made herein without departing from the scope and spirit of the invention.

What is claimed is:

1. A cleaning apparatus used for golf balls comprising:
a cloth; and
a magnet attached to said cloth.

2. The cleaning apparatus of claim 1, wherein said cloth is a microfiber cloth.

3. The cleaning apparatus of claim 1, wherein said cloth has four corners and said magnet is attached to said cloth at one of said corners.

4. The cleaning apparatus of claim 1 further comprising a divot tool attached to said magnet.

5. The cleaning apparatus of claim 1, further comprising a clip attached to said magnet.

6. The cleaning apparatus of claim 1, further comprising a clip and divot tool attached to said magnet.

7. A cleaning apparatus used for golf balls comprising:
a cloth; and
two or more magnets attached to said cloth.

8. The cleaning apparatus of claim 7, wherein said cloth is a microfiber cloth.

9. The cleaning apparatus of claim 7, further comprising a divot tool attached to one of said magnets.

10. The cleaning apparatus of claim 7, further comprising a clip attached to one of said magnets.

11. The cleaning apparatus of claim 1, further comprising a clip and divot tool attached to one or more of said magnets.

12. A cleaning apparatus used for golf balls comprising:
a cloth; and
a magnet embedded in said cloth.

13. The cleaning apparatus of claim 12, wherein said cloth is a microfiber cloth.

14. The cleaning apparatus of claim 12, wherein said cloth has four corners and said magnet is embedded in said cloth at one of said corners.

15. The cleaning apparatus of claim 12, further comprising a divot tool attached to said magnet.

16. The cleaning apparatus of claim 12, further comprising a clip attached to said magnet.

17. The cleaning apparatus of claim 12, further comprising a clip and divot tool attached to said magnet.
